(19) United States
(12) Patent Application Publication
(10) Pub. No.: US 2003/0080171 A1
(43) Pub. Date: May 1, 2003

(54) Nailing machine

(75) Inventors: Satsuo Sato, Ibaraki (JP); Takuhiro Murakami, Ibaraki (JP); Kunio Yamamoto, Ibaraki (JP)

Correspondence Address: McGinn & Gibb, PLLC, Suite 200, 8321 Old Courthouse Road, Vienna, VA, 22182-3817, US

(73) Assignee: Hitachi Koki Co., Ltd., Tokyo (JP)

(21) Appl. No.: 10/279,974

(22) Filed: Oct. 25, 2002

(30) Foreign Application Priority Data
Oct. 26, 2001 (JP) P.2001-329316

(51) Int. Cl. B25C 5/02

(52) U.S. Cl. 227/119

(57) ABSTRACT

A nailing machine, such as a pneumatic nailing machine, in which a part constituting a nose is changed so as to increase the service life of a driver blade for driving a nail. The nailing machine includes a nose having a nose hole in which the nail is supplied, and the driver blade made of metal. At least a part of a surface of the nose hole to be in contact with a front surface of the driver blade is provided with a protective body. The protective body is made of an organic material or a composite material of an organic material and a metal material. Due to this, direct mutual contact of the metal parts is prevented.

### BACKGROUND OF THE INVENTION

1. Field of the Invention

The present invention relates to a nailing machine, such as a pneumatic nailing machine, in which a part constituting a nose is changed so as to increase the service life of a driver blade for driving a nail.

2. Background Art

As well known, the nailing machine operates such that the driver blade is driven to move at high speed by the utilization of pressure of a compressed air or the like and it drives a nail into an object to be worked. In the case of driving nails having round heads, which are connected by plastics or a wires it is a common practice that the cross section of the driver blade is configured to be crescent or semicircular so as to avoid that it does not drive the next nail.

Great impact force acts on the driver blade (referred simply to as “blade”). In the case of the blade having the such configured cross section, the gravity center of the blade is not aligned with the center line of the piston. The result is that a great bending is apt to occur in the blade. At this part, the blade inevitably contacts with the nose hole surface part 7. In this case, the metal surfaces contact with each other at high speed. The contact surfaces are heated to be several hundreds ° C. or higher locally, and alteration layers are formed in the surface regions of both the surfaces. In the blade, minute cracks are formed in the alteration layer and grows into fatigue fracture. The result is that the product service life is reduced. There is an approach to solve the problem in which the nose part is made of a sintered metal and impregnated with oil. However, it is the present state that the solution provided by the approach is still unsatisfactory.

### SUMMARY OF THE INVENTION

Accordingly, an object of the present invention is to provide a nailing machine which is free from the defects of the conventional art, and is capable of increasing the life of the blade.

To achieve the above object, in the present invention, the nose hole surface part is made of an organic material or a composite material of an organic material and a metal material. With this novel and unique feature, the metallic members never directly contact with each other at the part of the blade at which bending stress is generated when the nail is driven.

### BRIEF DESCRIPTION OF THE DRAWINGS

FIG. 1 is a cross sectional view showing an embodiment of a nose of a nailing machine according to the present invention.

FIG. 2 is a cross sectional view taken on line X-X in FIG. 1.

FIG. 3 is a cross sectional view showing a conventional nose, which the view corresponds to that of FIG. 1.

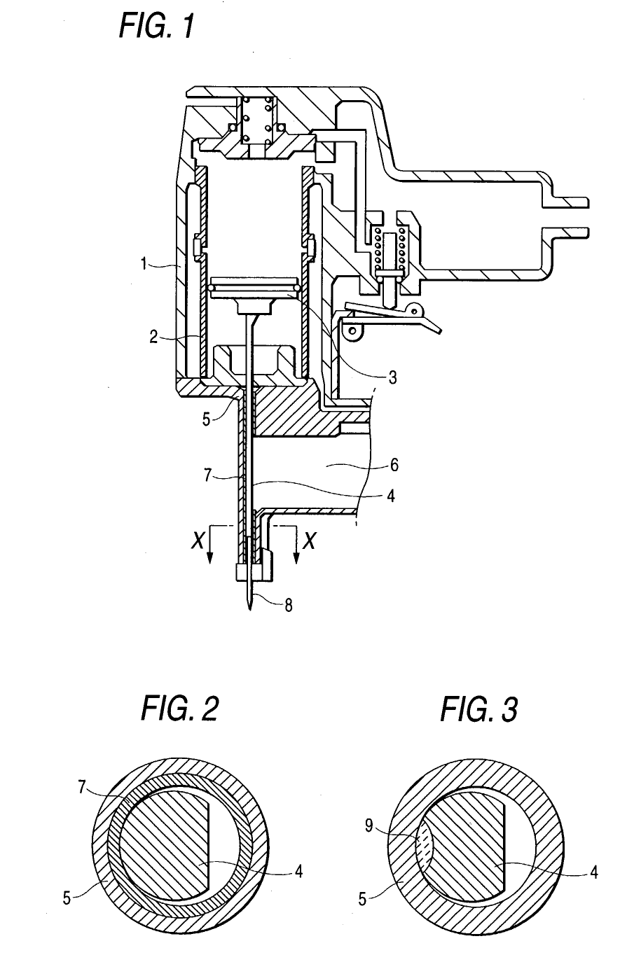

### DETAILED DESCRIPTION OF THE PREFERRED EMBODIMENTS

An embodiment of the present invention will be described with reference to the accompanying drawings. In the figures, reference numeral is a housing of the nailing machine body; 2 is a cylinder; 3 is a piston; 4 is a driver blade mounted on the piston 3; 5 is a nose which is provided in a lower part of the housing 1 and has a through hole through which the driver blade 4 and a nail 8 pass; 6 is a magazine for feeding nails to the nose hole; 7 is a nose hole surface part; 8 is a nail; and 9 is an alteration layer generated by quenching during a high speed contact of the driver blade 4 with the nose 5.

The driver blade 4 mounted on the piston 3 drives nails 8 fed by the magazine 6 into an object to be worked. The nails 8 fed from the magazine 6 are generally connected together. A tip of the driver blade 4 is crescent or semicircular in cross section in order to avoid that it simultaneously drives two adjacent nails into the object. Accordingly, when the driver blade 4 is ejected at high speed under high pressure by the piston 3 and hits the connected nails 8, and when the nail 8 is driven into the object, considerably large load acts on the driver blade 4, and bending stress is generated in the driver blade. As a result, metal contact parts under high speed and pressure condition are formed between the driver blade 4 and the nose hole surface part 7. The metal contact parts are instantaneously heated to have high temperature, and a quenching layer, called an alteration layer 9, having a thickness of several tens to several hundreds μm, is formed. And, a softened layer is locally formed in a lower part of the layer. The alteration layer is 800 or higher in Vickers hardness, and very fragile. Accordingly, minute cracks are easy to be formed in the alteration layer. Fatigue fracture grows with the cracks of the alteration layer as starting points, and eventually the blade is broken down. This phenomenon frequently occurs.

In the nail driving driver blade 4 of which the tip is crescent or semicircular in cross section, the phenomenon is frequently found. And it is readily estimated that in any case, the breakdown starting points are present on the front side of the driver blade 4, i.e., a bending stress generated part. In the current nailing machine, the load acts on the driver blade 4, and hence, the contact of the driver blade 4 with the nose hole surface part 7 is unavoidable. Further, the driver blade 4 is moved while being in a cantilever fashion, and hence, it is very difficult to eliminate the vibration of the driver blade. Current efforts to solve the blade breakdown problem are directed to improvement of the material and mass of the driver blade 4. In the light of gaining high output and weight reduction, engineers are required to take another approach to increase the service life of the driver blade 4. For the above background reasons, the inventors made much efforts to improve the material of the nose hole surface part 7 which is in contact with the driver blade 4, with an intention of increasing the life of the driver blade 4. It is inevitable that the driver blade 4 contacts with the nose hole surface part 7. Therefore, we suppressed the heat generation at this part when those contact with each other, and succeeded in preventing the formation of the alteration layer 9, and in increasing the lifetime of the driver blade 4. In the case of the driver blade 4 having the crescent or semicircular tip to which our creative efforts are directed, an organic material or a composite material of a metal material containing the organic material, not an iron-based metal, is used for the material constituting the nose hole surface part 7. With use of such kinds of materials, the service life of the driver blade 4 is successfully increased.

As described above, the whole or part of the nose hole surface part being in contact with the front surface of the driver blade is a protective part made of an organic material or a composite material of an organic material and a metal material. This technical feature is employed for minimizing the heat generation when the nose hole surface part is in contact with the driver blade 4. Specifically, an engineering plastic, e.g., polyacetal or reinforced nylon, is used to secure a lubricity, and its elastic deformation is utilized to lessen a contact resistance of the driver blade, whereby a heating value of generated heat is reduced. To form a composite material of the organic material and the metallic material, it is preferable that the metallic material is porous, and is impregnated with the organic material or the organic material is mechanically fixed to the porous metallic material. The porous material is used for maintaining a strength of the nose hole surface part or securing a lubricity. Accordingly, so long as the porous material is metallic, it should be avoided to employ such a structure as to allot the entire impart the bending stress of the driver blade 4 to the porous material part and as to have a strength capable of enduring such bending stress. Sometimes, the porous material is impregnated with oil for the purpose of providing supplemental lubrication. In the invention, an area of the protective part is the whole or part of the hole of the nose 5. The reason for this follows. If the driver blade 4 does not contact with the nose 5, no problem arises. Therefore, if the mechanism clearly shows the contact part, it suffices that the protective part is applied to only that contact part. So long as the blade per se moves, vibration inevitably occurs in the driver blade 4 and varies also depending on movement conditions. When this fact is taken into consideration, it is most preferable that the protective part is formed over the whole hole of the nose.

Further, the invention has a characteristic feature that the nose hole surface part is integrated into the nose hole surface part by fitting or the like. With this feature, the nose hole surface part is formed in the simplest manner, and it is replaceable with another new one. The organic material is much lower in hardness than the metallic material. Accordingly, it is excellent in lubricity, but the wear life of it is inevitably shorter than that of the metallic material. When with its contact with the nail 8 and the driver blade 4, the wear of the nose hole surface part progresses to an extent in excess of a predetermined level, it is convenient that only the nose hole surface part 7 is replaceable with another new one.

As seen from the foregoing description, the invention prevents the bending stress generated part of the driver blade from coming in direct metal contact with the metal part of the nose. Accordingly, an alteration layer is not formed in the surface region of the nose hole surface part, and the fatigue breakdown starting from the alteration layer does not occur. Consequently, increase of the service life of the driver blade is ensured.

What is claimed is:

1. A nailing machine for driving a nail, comprising:
a nose having a nose hole; and
a driver blade for hitting the nail supplied in the nose hole;
wherein at least a part of a surface of the nose hole to be in contact with a front surface of the driver blade is provided with a protective body.

2. The nailing machine as claimed in claim 1, wherein the protective body is made of an organic material or a composite material of an organic material and a metal material.

3. The nailing machine as claimed in claim 1, wherein the driver blade has a cross section being not circular.

4. The nailing machine as claimed in claim 1, wherein the protective body is press-fitted to the nose.

5. The nailing machine as claimed in claim 2, wherein the protective body is formed with a porous metallic material and organic material, the organic material is impregnated in or mechanically fixed to the porous metallic material.
